(19) United States
(12) Patent Application Publication
(10) Pub. No.: US 2020/0288853 A1
(43) Pub. Date: Sep. 17, 2020

(54) TOOL HEAD CLAMPING SYSTEM

(71) Applicant: Saul Siegman, Lakewood, NJ (US)

(72) Inventor: Saul Siegman, Lakewood, NJ (US)

(21) Appl. No.: 16/353,477

(22) Filed: Mar. 14, 2019

(51) Int. Cl. A46B 5/00; B25G 3/12

(52) U.S. Cl. CPC A46B 5/0095; B25G 3/12

(57) ABSTRACT

A tool head clamping system allows for the interchangeability of various cleaning tool accessories. These accessories are connected by a clip assembly to a mop handle or like elongated hand tool handle. The system utilizes a novel male clip member to female clip member connection, with the female clip member located on the end of the elongated tool handle and the corresponding male clip member located on the cleaning tool accessory to be attached to the handle.

### RELATED APPLICATION

This application claims the benefit of provisional application Ser. No. 62/645,234, filed on Mar. 20, 2018.

### BACKGROUND OF THE INVENTION

There are numerous manually operated cleaning tools e.g. mops, brooms, scrappers, shovels, etc., having elongated handles. However, to accomplish the varied cleaning functions for which these tools are used, money must be spent to purchase each individual tool. While there currently are some handled cleaning tools which have interchangeable heads, very few are available for use with more commonly used cleaning tools like brooms and mops. And there are no tool head clamping systems which effectively allow for the attachment of a variety of cleaning tool accessories to handles, while also allowing for the accessories to be quickly and easily attached and detached from the handles.

### SUMMARY OF THE INVENTION

It is thus the object of the present invention to provide a Tool Head Clamping System which overcomes the limitations and disadvantages of existing interchangeable cleaning tool head accessary systems.

These and other objects are accomplished by the present invention, a unique tool head clamping system which allows for the interchangeability of various cleaning tool accessories. These accessories are connected by a clip assembly to a mop handle or like elongated hand tool handle. The system utilizes a novel male clip member to female clip member connection, with the female clip member located on the end of the elongated tool handle and the corresponding male clip member located on the cleaning tool accessory to be attached to the handle.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective front view of the male clip member of the present invention.

FIG. 2 is a perspective rear view of the male clip member of the present invention.

FIG. 3 is a perspective view of the female clip member of the present invention secured to the distal end of a cleaning tool handle.

FIG. 4 is a blow-up, perspective view of the distal end of a cleaning tool handle, with the male clip member positioned for insertion into the female clip member.

FIG. 5 is a perspective view of the distal end of a cleaning tool handle, with the male clip member attached within the female clip member.

FIG. 6 shows the tool head clamping system of the present invention utilized with a tool accessory, such as a scrub brush.

### DETAILED DESCRIPTION OF THE INVENTION

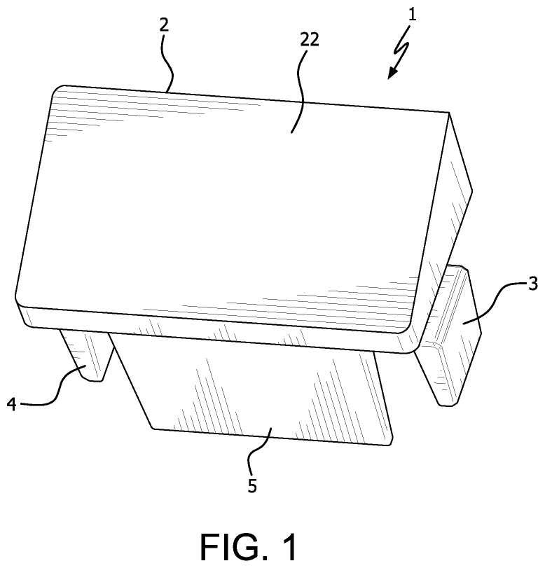

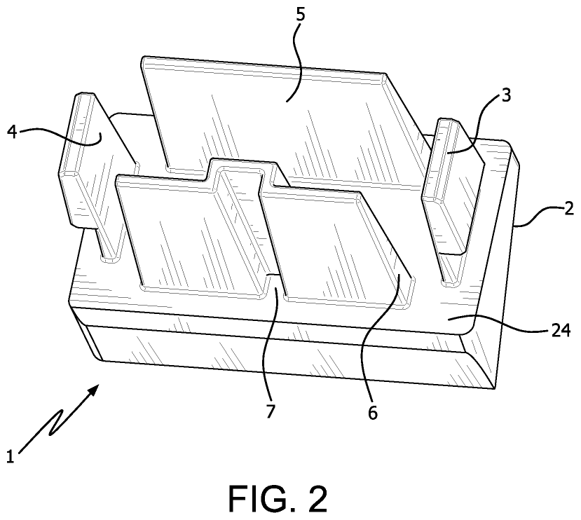

The tool head clamping system of the present invention comprises male clip member 1, best shown in FIGS. 1 and 2, having main body section 2, resilient lateral tabs 3 and 4, front wall 5, rear wall 6, and slot 7 inset within the rear wall, the front wall being positioned parallel to the rear wall.

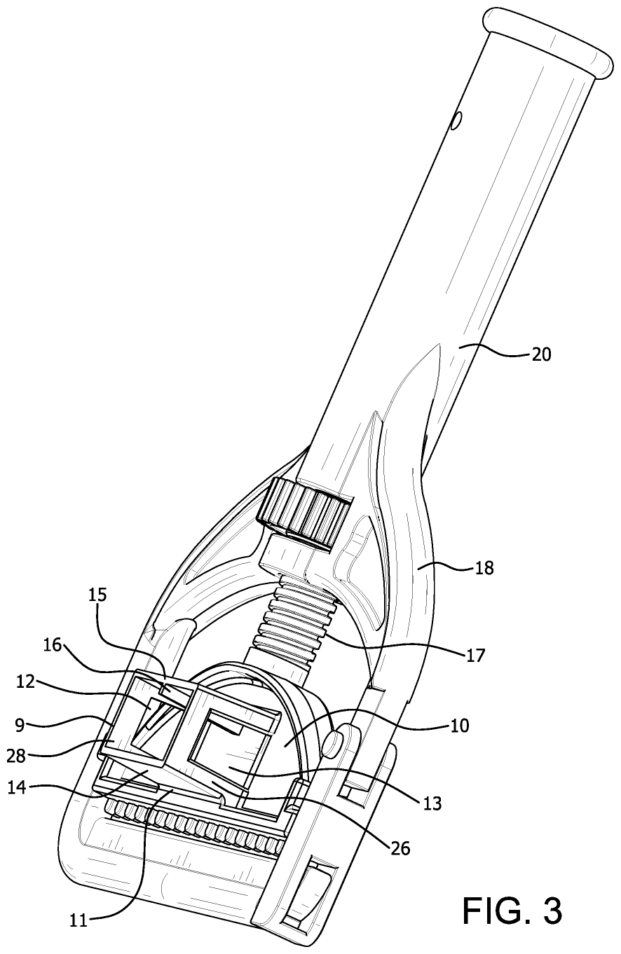

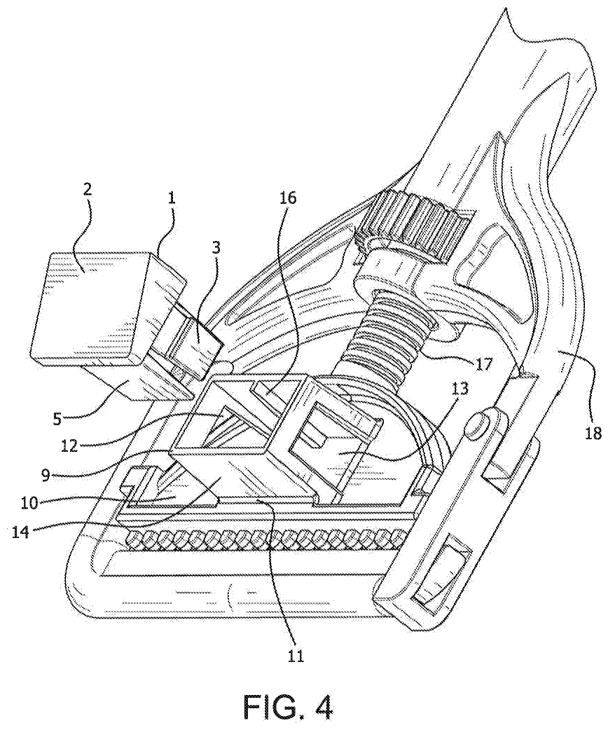

Female clip member 9, best shown in FIGS. 3 and 4, comprises base 10 and upstanding frame member 11 having lateral windows 12 and 13, front wall 14 and rear wall 15. Tab 16 extends from rear wall 15. Base 10 of female clip member 9 is attached to distal end 17 of elongated tool handle 20. Yoke member 18, circumscribing female clip member 9, is attached to handle 20.

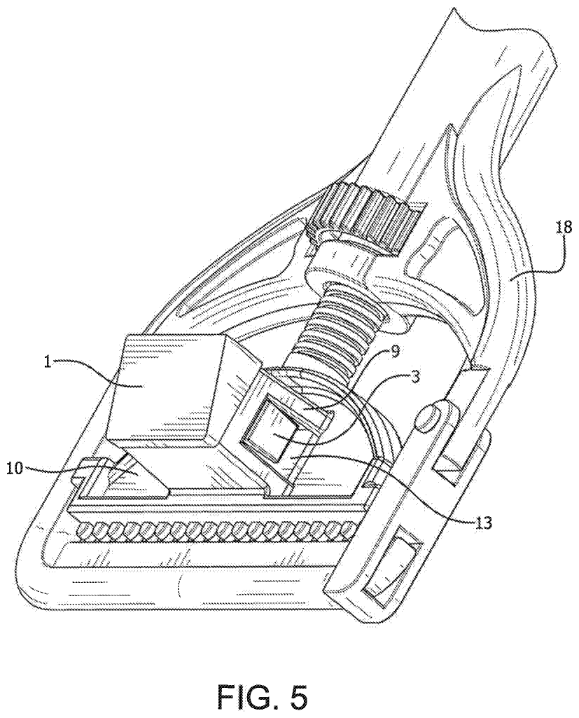

As best seen in FIGS. 4 and 5, male clip member 1 is configured to be inserted into frame member 10 of female clip section 9, by pushing resilient tabs 3 and 4 inward and inserting the male clip member into the frame member such that the tabs are positioned within the lateral windows 12 and 13. The resiliency of tabs 3 and 4 allows them to be pushed inward and then spring outward into lateral windows 12 and 13. In this position, front wall 5 of male clip member 1 rests on the inner surface of front wall 14 of the female clip section, and tab 16 of the female clip member fits snugly within slot 7 of rear wall 6 of the male clip member.

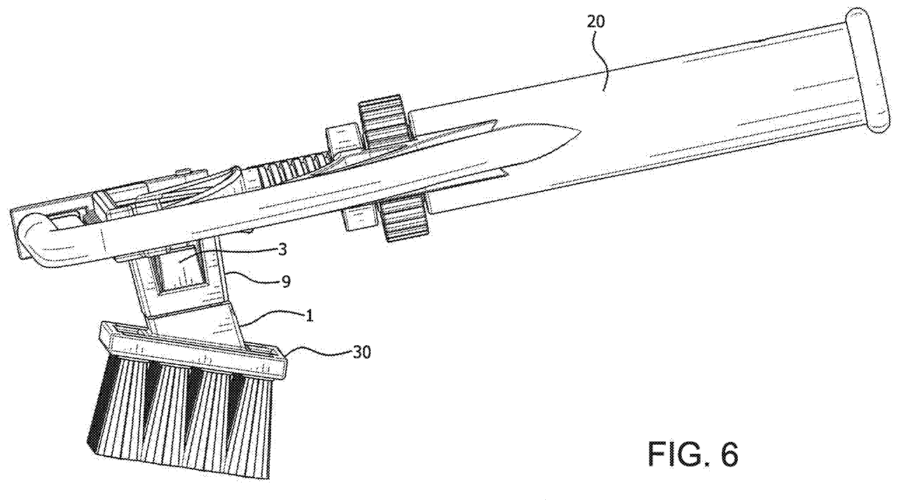

A variety of cleaning tool head accessories can be secured to the front surface of main body section 2 of male clip member 1. For example, FIG. 6 shows scrub brush attachment 30 secured to and extending from main body section 2. In like manner, other cleaning tool head accessories, such as but not limited to, sponge members, scrub pads, dustpans, shovels, scrappers, bulb-changing devices, and squeegees can be secured to the main body section of a male clip member.

A tool head accessory which is attached to female clip member 9 can easily and quickly be removed from handle 20 by simply pushing tabs 3 and 4 inward and then lifting male clip member 1 up and away from the handle. An alternate tool head accessory having a male clip member 1 attached, can then be secured within female clip member 9 and to handle 20.

In this manner, a number of tool head accessories are provided for use with a single handle, each available to be interchanged depending on the desire and requirements of the user.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A tool head clamping system for a hand tool having an elongated handle and an accessory cleaning head, said system comprising:
a male clip member comprising a main body section secured to the accessory cleaning head, said main body section having a top surface and a bottom surface, lateral tab members located on and extending up from the bottom surface of the main body section, a front wall located on and extending up from the bottom surface of the main body section, a rear wall located on and extending up from the bottom surface of the main body section, and a slot inset into the rear wall and extending up from the bottom surface and extending the height of the rear wall; and
a female clip member comprising a base secured to the distal end of an elongated handle, and a box-shaped frame member extending up from the base, said frame member having a rear located on and extending up from the base, a front wall located on and extending up from the base, and lateral framing members extending between the rear wall and the front wall, each framing member having a lateral window therethrough, said rear wall having a rear tab;
whereby the female clip member is configured to receive the male clip member and to secure the male clip member with its accessory cleaning head to the distal end of the elongated handle.

2. The tool head clamping system as in claim 1 wherein the lateral tab members of the male clip member are received within the dual lateral windows of the frame member of the female clip member and the rear tab of the female clip member is received within the slot of the male clip member to secure the male clip member with its accessory cleaning head to the distal end of the elongated handle.

3. The tool head clamping system as in claim 1 wherein the front wall and the rear wall of the main body are positioned parallel to each other.

4. The tool head clamping system as in claim 1 wherein the accessory cleaning head is a scrub brush.
